(19) United States
(12) Patent Application Publication
(10) Pub. No.: US 2004/0066890 A1
(43) Pub. Date: Apr. 8, 2004

(54) Method and apparatus for analysing and sorting a flow of material

(76) Inventors: Wijnand Ludo Dalmijn, Amsterdam (NL); Tako Pieter Rinze De Jong, The Hague (NL); Norbert Fraunholcz, Zoetermeer (NL); Hylke-Jan Glass, Delft (NL)

Correspondence Address: PEACOCK MYERS AND ADAMS P C, P O BOX 26927, ALBUQUERQUE, NM, 871256927

(21) Appl. No.: 10/461,103

(22) Filed: Jun. 13, 2003

(30) Foreign Application Priority Data
Dec. 14, 2001 (WO) PCT/NL01/00909
Dec. 15, 2000 (NL) NL 1016916

(51) Int. Cl. G01N 23/04

(52) U.S. Cl. 378/57

(57) ABSTRACT

The invention relates to a method and an apparatus for analyzing a flow of material using X rays. The method comprises radiating the material with at least two energy levels and measuring the transmission of radiation through the material for each level separately, and is characterized in that a sensor is used for measuring the radiation transmission, which sensor comprises a plurality of substantially adjacent pixels, and on the basis of the transmission values measured determining the thickness and composition of the material. This may be performed in combination with one or more blank contact detection techniques, for example on the basis of infrared radiation, visible light radiation, of ultraviolet radiation.

The present invention relates to a method and an apparatus for analysing and sorting a flow of material. The invention relates in particular to a method and apparatus for analysing and sorting a flow of material by means of X-ray. To this end the method comprises the steps as mentioned in the preamble of claim 1.

Such a method is known in the art. For this purpose batteries are radiated with the aid of X-rays having two levels of energy. The total transmission of the two radiation levels is determined separately. On the basis of the measured total transmission it is then possible to determine the type of battery. A method of this kind has very limited possibilities. As only the total transmission is measured, it is not possible to analyse parts of the battery separately. Nor is it possible to analyse small, separate objects simultaneously.

It is the object of the invention to provide an improved method, whereby the above-mentioned drawbacks are eliminated. A particular object of the invention is to provide an improved method by which objects can be analysed and detected separately. It is also an object of the invention to provide an improved method by which it is possible to analyse and detect and optionally to separate various objects that differ from one another.

To this end the invention provides a method characterized in accordance with claim 1. On the basis of the measured transmission values the method according to the invention makes it possible to at least estimate in each pixel the thickness, the adsorption coefficient and the mean effective atomic number of the material. Separation may occur automatically as well as manually, based on the information provided by the apparatus.

According to a preferred embodiment, the sensor comprises a plurality of substantially linearly oriented sensor pixels, and the flow of material is conducted into a direction at least approximately perpendicularly to the row of sensor pixels, while the transmission is measured substantially continuously. If the flow of material is fed continuously through the apparatus, with the radiation being emitted at a first side of the flow of material and the sensors being placed at a second side, a clear image of the material supplied may be obtained. Depending on the distance between adjacent sensor pixels, the resolution may be increased or reduced.

According to a further preferred embodiment, the transmission measurement may be carried out at a previously chosen frequency. This frequency may, for example, be at least 20 Hz, but is typically 200 Hz and higher. This frequency is also dependent on the supply rate of the flow of material. Preferably, the horizontal (i.e. substantially parallel to the row of sensor pixels) resolution is approximately equal to the vertical (i.e. in the direction of movement of the flow of material) resolution.

According to a further preferred embodiment the method is characterized in that the information about the transmission value that is obtained for each pixel is fed to an image processor, and that with the aid of the image processor at least differences in composition among the particles, form and dimension of various particles in the flow of material, are determined. This allows proper and accurate classification of the particles. It is, for example, possible to provide a separating apparatus located upstream in the material flow's processing path by means of which the various types of material may be removed as desired.

According to one preference, the invention is characterized in that the transmission in each sensor pixel is determined during consecutive units of time such that measurements can be carried out on the flow of material adjacent in the direction of movement.

According to another preference, the invention is characterized in that the flow of material is moved over a conveyor surface, while the flow of material is from a first side of that surface irradiated by an X-ray source and the radiation transmission is detected at the opposite side of that surface.

According to one preferred embodiment, the method according to the invention is combined with one or more further contact-free detection techniques, for example, on the basis of radiation selected from a group consisting of: infrared radiation, visible light radiation, ultraviolet radiation or electromagnetic radiation, for example, on the basis of sensors that operate with low frequency electromagnetic fields (100-100,000 Hz). This results in the advantage that materials, which with respect to effective atom composition differ very little from each other, may be analysed on the basis of other properties that are determined with the aid of other detection techniques.

According to yet another preferred embodiment, the material flow is chosen from similar materials that differ in composition. For example, the material may comprise different kinds of glass, different kinds of metal, different kinds of organic substances and inorganic substances, different kinds of solid fossil fuels, different kinds of synthetics, mixtures of incineration residues or miscellaneous products having a complex composition. It is also possible that materials are mixed with other types of pollutants, which may be analysed very conveniently by means of the method according to the invention. It is also possible to detect polluting areas within a single particle. It is, for example, possible to accurately differentiate between solid fossil fuels and rocks.

In the method according to the invention the radiation is X-ray radiation. It is in particular preferred that at least two radiation levels are used having an average energy difference of at least 10 keV, preferably at least 20 keV, more preferably at least 40 keV and still more preferably at least 70 keV. In accordance with a further preferred embodiment the radiation is X-ray radiation wherein the level of the first part has an energy level between approximately 10 and 100 KeV, and the other part has an energy level between approximately 100 and 200 keV. In some applications these levels may be adjusted in accordance with requirements.

As mentioned, the invention also relates to an apparatus for analysing a flow of material with the aid of radiation, which apparatus comprises at least one supply means for moving a flow of material through the apparatus in a first direction, radiation emitting means for radiating the material, and sensors for measuring the radiation transmitted through the material, and which apparatus is characterized in that the radiation-emitting means emit radiation of at least two energy levels, and the sensors measure the radiation of the various energy levels, the sensors comprising a plurality of substantially adjacent measuring points that are placed substantially in a row substantially perpendicular to the direction of movement of the material. Such an apparatus makes it possible to very accurately detect separate objects in a flow of material. It is particularly preferable for such an apparatus to comprise image processing means, allowing at least the shape and dimension of different objects in the flow of material to be determined. Pollutants within a particle can also be detected. The apparatus preferably comprises means by which the flow of material can be analysed with the aid of one or more further contact-free detection techniques, for example, based on infrared radiation, visible light radiation, ultraviolet radiation or electromagnetic fields.

The invention will be elucidated below with reference to a number of examples of preferred embodiments.

According to the invention, the method of a first embodiment is performed by measuring the transmission of X-ray radiation at two different keV areas and at a resolution of approximately 2×2 mm. This means that the centre-to-centre distance between the sensor pixels is approximately 2 mm. The rate of movement of the material to be analysed in the plane located between the radiation source and the sensor and the frequency at which measuring is performed determines the earlier mentioned vertical resolution. If no material is supplied, a maximum transmission is measured. If there is any material between the radiation source and the sensor, the measured radiation value will be lower than said maximum value.

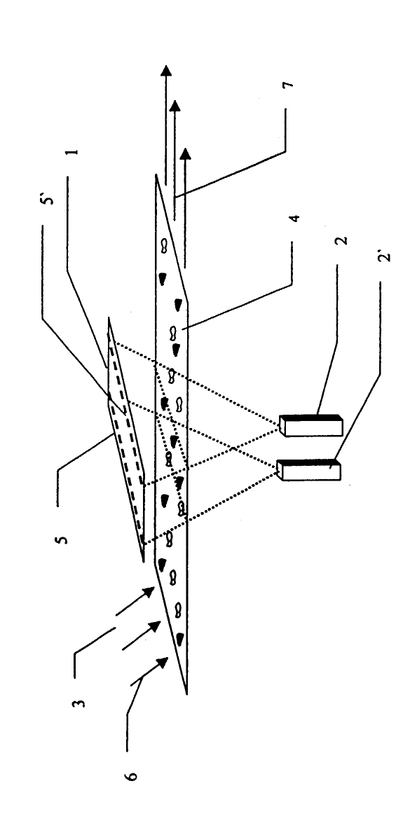

FIG. 1 schematically shows an apparatus with which the method according to the invention can be performed. In the embodiment illustrated, the apparatus comprises two so-called line sensors 5 and 5′, respectively, as well as radiation sources 2 and 2′, respectively located at a distance therefrom. As shown, there are two separate radiation sources 2 and 2′, respectively, which emit radiation in the direction of the sensors 5 and 5′, respectively. The radiation sources 2, 2′ emit radiation of different energy levels. Both of the line sensors 5, 5′ are only sensitive to one of the energy levels as emitted by the radiation sources 2, 2′. As shown, the material 3 to be analysed, is supplied in the form of solid particles and of different compositions, indicated in FIG. 1 by different shades of grey of the particles, in one direction indicated by the arrows 6, wherein the particles are fed between the line sensors and the radiation sources in the direction of the arrows 7. As shown in FIG. 1, the line sensors are placed approximately perpendicularly to the direction of movement of the particles. The line sensors may also be placed at an angle to the direction of movement of the flow of material.

The particles may be fed between the sensors and the emitter in a horizontal transport plane, for example, over a conveyer belt. However, it is also possible for the particles to be supplied falling, vertically or at an angle, but a movement over a sloping plane is also possible. Preferably the velocity of the particles to be analysed is known.

The transmission values measured by the line sensors 5, 5′ are fed to an image processor 1. This processing unit, for example a computer, has the ability of determining the shape and size of the particles by a combination of the frequency of the measurements and the transport rate of the particles in combination with the resolution obtained by the plurality of separate sensors in the lines 5 and 5′. The image processor is preferably provided with memory means for storing the data obtained.

The velocity of the particles may cover a wide range, but a velocity of at least 5 cm per second is preferred. According to a further preferred embodiment, the rate is at least 20 cm per second, more preferably at least 0.5 meter per second, even more preferably at least 1 m per second and most preferably at least 2 meters per second. Depending on the resolution, i.e. the number of pixel on the line sensors 5 and 5′, solid particles having a size of, for example, more than 1 mm can be detected.

As shown in the figure, the sensors are stationary and the particles are fed through the apparatus. However it is also possible, to move the sensors and optionally the radiation sources over a stationary surface on which the particles are present.

The width of the surface 4, over which the particles in the illustrated embodiment are fed, is at least as large as the particles to be analysed. Preferably the width is at least a multiple of the width of the particles.

If the particles are fed over a conveyor belt or over a sloping surface, this should be at least partly and preferably completely permeable to the radiation used. In the case of X-ray radiation, the energy level of the radiation preferably ranges from 10 keV to approximately 200 keV.

Instead of the embodiment with two separate line sensors that is shown, it is possible to use one line sensor comprising two lines: the one line being sensitive to the relatively low energy level, the other line being sensitive to the relatively high energy level. A sensor may also be alternately sensitive to low and high energy levels. Such a sensor is known in the art. According to a further embodiment it is possible to use sensors that are sensitive to a particular range of radiation energy, or that are sensitive to more than one range of radiation energy. The various respective part areas should then be preferably clearly separated from one another.

Depending on the image processor to be used, it is then possible to measure transmissions at least 20× per second (20 Hz). According to a preferred embodiment, this is read at least 100× per second, according to a further preferred embodiment, at least 200× per second.

By means of the invention it is possible to detect differences in the particle's composition, in addition to which it is possible to determine the shape and size of the particles, and it is possible to determine the internal structure of the particles as well as local differences in composition within the particle.

The data processing system 1 is able to determine the size, the thickness, the circumference, the texture, etc. of the particles supplied. Structures of part areas within a single particle can optionally also be detected.

The transmission value measured depends on the radiation intensity of a source (I₀), the absorption coefficient of the particle (μ, which is a function of the wave-length λ), and the thickness of the material to be identified (d). This relation is as follows: I=I₀·e^{-μ(λ)}·^{d}. By measuring at two radiation energy levels (one level of high keV and one level of low keV), it is possible to approximate both the thickness of the material d, and the absorption coefficient μ. As the thickness is in both cases the same, it is possible to calculate the ratio μ_{high}/μ_{low}, which is a thickness-independent characteristic value of the material.

As the material moves in a certain direction, which is known, it is possible to calculate the shape and therefor the size of individual particles with the aid of successive measurements using the line sensors and the known resolution.

It is possible to determine relative differences in thickness of the particle even if the composition of the particle is not entirely homogeneous or constant. In that case the measured intensity I will depend on the thickness of the particle.

By using the parameter μ_{high}/μ_{low} it is possible to measure thickness-independent material differences in the particles.

The determined characteristics are registered by means of memory means in the image processor 1, and after statistical processing these can be recalled directly by the user and/or they can be used to control an actuator mechanism, which is capable of separating the flow of particles into at least two flow parts. This mechanism-may be comprised of, for example, compressed air sources, which blow the particles into a desired direction. Such techniques are known in the art.

This system is suitable for the inspection of all the material that is present in the form of solid particles, and which has a minimum size of approximately 1 mm. The system is in particular suitable for the inspection of raw materials of primary origin (e.g. mining) or of secondary origin (obtained by deconstruction activities, such as for example, demolition, dismantling or reduction, or as residual flow from construction processes such as, for example, the processing of material, production of goods and construction activities), wherein the minimum particle size may be, for example, 1 mm or larger, for example, approximately at least 5 mm.

The system according to the invention has been shown to be especially suitable for the following applications:

1. The identification and optional separation of non-ferrous metal alloys from a mixture into particular separate metals and alloys, for example the non-magnetic fraction from shredded cars, electronic and other discarded user goods. The system is particularly suitable for separating various aluminium alloys from magnesium alloys.

2. The identification and optional separation of certain types of glass that are detrimental to the remelting process, from recycle glass (packaging glass), especially heat resistant glass and leaded glass.

3. The identification and optional separation of components that are detrimental to incineration, for example chlorine- and bromium-rich synthetic components, heavy metals, etc. from flows of mixed secondary organic fuels and waste, for example shredder waste, domestic and other industrial waste.

4. The identification and optional separation of various types of synthetics, for example, the separation of synthetics of one type either with filler or without filler, the separation of PS and PMMA, or of PET and PVC.

5. The identification and optional separation of wood residues, gipsum, asbestos, synthetic materials, metals and other pollutants from flows of material originating from construction and demolition activities.

6. The identification and optional separation of pollutants, in particular shale and other minerals from mined coal.

7. The control of a thermal incineration plant based on data obtained by means of the described detection system from the supplied flow of material.

8. The identification and optional separation of lumps of ore having a low or high content of metal-containing minerals.

9. The identification and optional separation of organic substances, for example wood, from sand and gravel.

10. The identification and optional separation of different qualities and types of industrial textile and leather.

It will be obvious that the apparatus according to the invention is not limited to the above-mentioned separation processes, nor is it limited to the embodiment illustrated in the figure.

What is claimed is:

1. A method for analysing the contents of a previously determined material in a heterogeneous flow of material with aid of radiation to allow the contentx of the material to be determined in the flow of material, the method comprising the steps of:
a) radiating the material with X rays having at least two energy levels;
b) measuring transmission of radiation through the material for each energy level separately;
c) measuring the radiation transmission by means of a sensor; and
d) on the basis of the measured transmission values in the sensor, determining at least thickness and effective atomic composition of the material, wherein the sensor comprises a plurality of substantially adjacent pixels to allow the size and shape of individual elements in the flow of material to be determined, and wherein on the basis of the determinations the Determined material may be separated from the flow of material by means of sorting means.

2. A method according to claim 1, additionally comprising the steps of:
e) feeding data obtained for each pixel in d) to an image processor; and
f) determining with aid of the image processor at least the shape and size of individual particles in the flow of material.

3. A method according to claim 1, wherein during consecutive units of time the transmission is determined in each sensor pixel such that adjacent measurements are taken on the flow of material in a direction of movement.

4. A method according to claim 1, wherein the flow of material is moved over a first conveyor surface, wherein the flow of material is irradiated by an X-ray source from a first side of that surface and the radiation transmission is detected at an opposite side of that surface.

5. A method according to claim 1, wherein the method is performed in combination with a contact-free detection technique.

6. A method according to claim 1, wherein the flow of material is chosen from similar materials of different compositions.

7. A method according to claim 1, wherein the flow of material is chosen from the group consisting of mixtures of: different kinds of glass, different kinds of metal, different kinds of organic substances and inorganic substances, different kinds of solid fossil fuels, different kinds of ores, different kinds of synthetics, and incineration residues; or from such mixtures containing pollutants; or from a mixture of products of a complex composition.

8. A method according to claim 1, wherein the radiation is X-ray radiation, of which the at least two radiation levels have an energy difference of at least 10 keV.

9. A method according to claim 8, wherein the radiation comprises a part having an energy level between approximately 10 and 100 keV, and a part having an energy level between approximately 100 and 200 keV.

10. A method according to claim 1, wherein the sensor is oriented substantially perpendicular to the direction of movement of the flow of material and substantially perpendicular to the radiation source, and wherein the same comprises at least 25 pixels.

11. A method according to claim 5, wherein the contact-free detection technique comprises employing one or more of the group consisting of infrared radiation, visible light radiation, ultraviolet radiation, and electromagnetic fields.

12. A method according to claim 5, wherein the contact-free detection technique is employed in combination with an image processor.

13. A method according to claim 8, wherein the energy difference is at least 20 keV.

14. A method according to claim 13, wherein the energy difference is at least 40 keV.

15. A method according to claim 14, wherein the energy difference is at least 70 keV.

16. A method according to claim 10, wherein the sensor comprises at least 100 pixels.

17. A method according to claim 16, wherein the sensor comprises at least 500 pixels.

18. A method according to claim 17, wherein the sensor comprises at least 2500 pixels.

19. An apparatus for analyzing a flow of material, comprising a supply means for moving a flow of material through the apparatus in a first direction, radiation emitting means for radiating the material, and sensors for measuring the radiation transmitted through the material, wherein the radiation emitting means emit radiation of at least two energy levels, and the sensors measure the radiation of the various energy levels, the sensors comprising a plurality of substantially adjacent measuring points that are placed substantially in a row substantially perpendicular to a direction of movement of the material.

20. An apparatus according to claim 19, additionally comprising sorting means to allow a selective removal of material detected in the flow of material with aid of sensors.
